(19) United States
(12) Patent Application Publication
(10) Pub. No.: US 2025/0196358 A1
(43) Pub. Date: Jun. 19, 2025

(54) ROBOT SENSOR CALIBRATION METHOD AND ROBOT FOR REALIZING SAME

(71) Applicant: LG ELECTRONICS INC., Seoul (KR)

(72) Inventor: Hyeongshin JEON, Seoul (KR)

(73) Assignee: LG ELECTRONICS INC., Seoul (KR)

(21) Appl. No.: 18/709,403

(22) PCT Filed: Dec. 22, 2021
(86) PCT No.: PCT/KR2021/019557

§ 371 Date: Nov. 6, 2024

(30) Foreign Application Priority Data
Nov. 12, 2021 (KR) 10-2021-0155560

(51) Int. Cl. B25J 9/16

(52) U.S. Cl. CPC B25J 9/1692; B25J 9/1653; B25J 9/1697

(57) ABSTRACT

The present invention relates to: a method for automatically calibrating sensors assembled in a robot while the robot capable of moving to a target location along a target path within an area having moving and/or stationary obstacles therein is operating in the field; and a robot capable of realizing same. The present invention provides the robot sensor calibration method comprising the steps of: detecting a reference object through a plurality of sensors of a robot operating along a path according to regional path planning; and by using a location of the reference object detected by a specific sensor among the plurality of sensors, modifying a sensor posture parameter value for each of remaining one or more sensors among the plurality of sensors.

### TECHNICAL FIELD

The present disclosure relates to a method of calibrating sensors provided in a robot capable of moving to a target position along a target path in an area in which a moving and/or stopping obstacle exists and a robot implementing the same.

### BACKGROUND ART

The robot has been developed for industry and has been responsible for a part of factory automation. Recently, a robot-applied field has been further enlarged, so that a medical robot, an aerospace robot, and the like are developed, and a home robot that can be used in a general home is also being made. Among these robots, there is a robot capable of self-driving.

While such a robot moves along a target path, when an obstacle appears around the robot, the robot may modify the target path so as not to collide with the obstacle and move toward a target position along another suitable movement path.

The robot may be provided with various sensors to detect surrounding obstacles and to determine whether moving along the target path.

When sensors are assembled or mounted on a robot during a robot manufacturing process, due to a prescribed margin for an assembly position, tolerance may occur in a sensor assembly position and/or direction (hereinafter referred to as “posture”) for each robot. In addition, when a robot is driven for a long time in the field, a change in the posture of a sensor may occur due to the distortion of a robot body, the loosening of screws, and the like. Such assembly tolerance and/or posture change may be a failure to accurately grasp a position of an obstacle. Thus, calibration for the posture of sensors assembled to a robot is essential.

Conventionally, in a shipping process after manufacturing a robot, posture calibration of a sensor is performed by a manual operation of an engineer. After the robot is shipped, the posture calibration of the sensor is performed by a manual operation of an engineer in a manner of collecting the robot regularly or paying an on-site visit.

### DISCLOSURE

### Technical Tasks

One technical task of the present disclosure is to provide a method of automatically calibrating sensors assembled to a robot during an op-site operation of the robot capable of moving to a target position along a target path in a moving and/or stopping obstacle existing area and a robot capable of implementing the same.

### Technical Solutions

In order to achieve the above object, provided is a method of calibrating a robot sensor, the method including detecting a reference object through a plurality of sensors of a robot during driving along a path according to a local path plan and modifying a sensor posture parameter value for each of at least one or more of the rest of sensors among a plurality of sensors based on a position of the reference object sensed by a specific one of a plurality of the sensors.

The modifying the sensor posture parameter value may include modifying the sensor posture parameter value so that the position of the reference object sensed by each of the rest of the sensors becomes the same as the position of the reference object sensed by the specific sensor.

The method may further include stopping the driving of the robot when a difference between the sensor posture parameter value before modification and the sensor posture parameter value after the modification is out of a preset threshold.

The method may further include estimating postures of a plurality of the sensors based on the position of the reference object sensed through a plurality of the sensors.

The method may further include determining identity of the reference object detected through a plurality of the sensors, wherein the modifying the sensor posture parameter value is performed based on admitting the identity of the reference object.

The reference object may be a corner at which two planes meet or a cylinder.

The reference object may be an object located in an area spaced apart by a prescribed distance from the robot so as to be sensed by all of a plurality of the sensors.

A plurality of the sensors may include a first RGB camera and a first 3D camera for sensing an object located in front, a second RGB camera and a second 3D camera for sensing an object located below, and a laser scanner for sensing an object positioned in front.

The first RGB camera and the first 3D camera may be located close to an upper end portion of the robot, the laser scanner may be located close to a lower end portion of the robot, the second RGB camera and the second 3D camera may be located between the first RGB camera and the first 3D camera and the laser scanner, and the specific sensor may be the laser scanner.

The method may further include modifying the sensor posture parameter value for each of a plurality of the sensors based on an average position of the reference object sensed by a plurality of the sensors.

In another technical aspect of the present disclosure, provided is a robot including a moving unit configured to move the robot, a plurality of sensors configured to sense an external object, and a controller configured to detect a reference object through a plurality of the sensors during driving along a path according to a local path plan and modify a sensor posture parameter value for each of at least one of the rest of a plurality of the sensors based on a position of the reference object sensed by a specific one of a plurality of the sensors.

### Advantageous Effects

Effects of a robot sensor calibrating method and a robot t implementing the same according to the present disclosure will be described as follows.

According to at least one of embodiments of the present disclosure, it is advantageous in automatically calibrating sensors assembled to a robot while the robot capable of moving to a target position along a target path in an area, in which a moving and/or stopping obstacle exists, is being operated on the spot.

In addition, when the sensors assembled to the robot are automatically calibrated, it is advantageous in preventing accidents that may occur due to malfunction of the robot by stopping the operation of the robot when the tolerance and/or change thereof is greater than or equal to a threshold.

### DESCRIPTION OF DRAWINGS

FIG. 1 is a block diagram illustrating components constituting a robot according to an embodiment of the present disclosure.

FIG. 2 is a diagram illustrating a robot having a plurality of sensing modules for sensing an external object according to an embodiment of the present disclosure.

FIG. 3 is a diagram illustrating object detection by a plurality of sensors before calibration and object detection by a plurality of sensors after calibration.

FIG. 4 is a diagram illustrating an obstacle map recognized by a robot in operation.

FIG. 5 is a diagram illustrating an environment in which a robot is driven according to an embodiment of the present disclosure.

FIG. 6 is a flowchart for posture calibration of sensors included in a robot according to an embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

The following embodiments of the present disclosure are intended to materialize the present disclosure and are not intended to restrict or limit the scope of the rights of the present disclosure. It is understood that the technical idea easily inferred by those skilled in the art, to which the present disclosure pertains, from the detailed description and embodiments of the present invention should fall within the scope of the rights of the present invention.

The foregoing detailed description should not be construed as limiting in all respects and should be considered to be illustrative. The scope of the present disclosure should be determined by the reasonable interpretation of the appended claims, and all modifications within the equivalent scope of the present disclosure are included in the scope of the present disclosure.

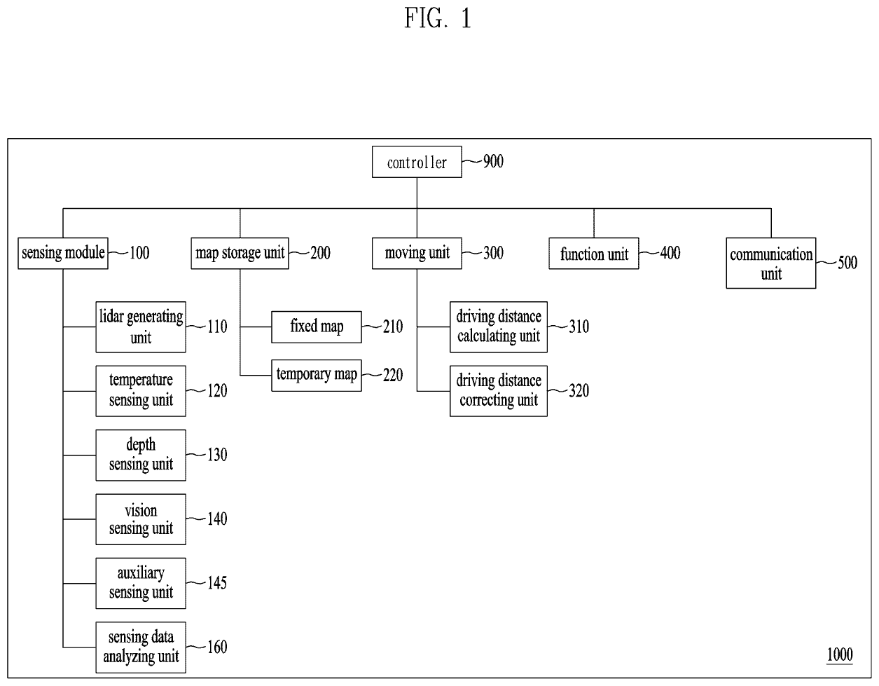

Components constituting a robot according to an embodiment of the present disclosure will be described with reference to FIG. 1. FIG. 1 is a block diagram illustrating components constituting a robot according to an embodiment of the present disclosure.

A robot 1000 may include a sensing module 100 for sensing a moving object or a fixed object disposed outside, a map storage unit 200 for storing various types of maps, a moving unit 300 for controlling the movement of the robot, a function unit 400 for performing a prescribed function of the robot, a communication unit 500 for transmitting and receiving information about a map or a moving object, a fixed object, or an external changing situation with another robot or a server, and a controller 900 for controlling each of these components.

FIG. 1 hierarchically configures the components of a robot, which shows the components of the robot logically. A physical configuration thereof may be different. That is, a multitude of logical components may be included in one physical component, or a plurality of physical components may implement one logical component.

The sensing module 100 senses external objects such as an obstacle and provides sensed information to the controller 900. According to an embodiment, the sensing module 100 may include a lidar sensing unit 110 that calculates a material and a distance of external objects such as a wall, glass, a metallic door and the like at a current position of the robot as an intensity and reflected time (speed) of a signal.

In addition, the sensing module 100 may include a temperature sensing unit 120 that calculates temperature information of objects disposed within a predetermined distance from the robot 1000. An embodiment of the temperature sensing unit 120 includes an infrared sensor that senses a temperature of a thing disposed within a predetermined distance from the robot 1000, particularly, body temperatures of people. When the temperature sensing unit 120 is configured with an infrared array sensor, a temperature of an object may be sensed without contact. When the infrared sensor or the infrared array sensor configures the temperature sensing unit 120, main information for checking whether a moving object is a person may be provided.

In addition, the sensing module 100 may further include a depth sensing unit 130 that calculates depth information between the robot and an external object and a vision sensing unit 140 in addition to the sensing units described above.

The depth sensing unit 130 may include a depth camera. The depth sensing unit 130 may determine a distance between the robot and the external object, and in particular, may be coupled to the lidar sensing unit 110 to increase the sensing accuracy of the distance between the external object and the robot.

The vision sensing unit 140 may include a camera. The vision sensing unit 140 may capture images of objects around the robot. In particular, the robot may identify whether an external object is a moving object by distinguishing between an image in which there is no change like a fixed object and an image in which a moving object is disposed.

In addition, a multitude of auxiliary sensing units 145 such as a heat sensing unit, a ultrasonic sensing unit, and the like may be disposed. These auxiliary sensing units provide auxiliary sensing information necessary to generate a map or sense an external object. In addition, the auxiliary sensing units also provide information by sensing an object disposed outside when the robot travels.

The sensing data analyzing unit 150 analyzes the information sensed by a multitude of the sensing units and transmits the analyzed information to the controller 900. For example, when an object disposed outside is sensed by a multitude of the sensing units, each of the sensing units may provide information about the characteristics and distance of the corresponding object. The sensing data analyzing unit 150 may perform calculation by combining values of the informations and transmit the calculation result to the controller 900.

The map storage unit 200 stores information of objects disposed in a space in which the robot moves. The map storage unit 200 may include a fixed map 210 that stores information about fixed objects, which have no variation or are disposed in a manner of being fixed, among objects disposed in an entire space in which the robot moves. A single fixed map 210 may be essentially included depending on a space. Since only objects having the lowest change in the corresponding space are disposed in the fixed map 210, it may sense more objects than objects than those indicated by the map 210 when the robot moves in the corresponding space.

The fixed map 210 essentially stores position information of the fixed objects, and may additionally include characteristics of the fixed objects, for example, material information, color information, other height information, etc. When a variation item occurs in the fixed objects, these additional informations facilitate the robot to check the variation item.

In addition, the robot may generate a temporary map 220 by sensing the surroundings in the process of moving, and compare the temporary map 220 with the fixed map 210 for the entire space stored in the past. As a result of the comparison, the robot may confirm a current position.

The moving unit 300 is a means for moving the robot 1000, such as a wheel, and moves the robot 1000 under the control of the controller 900. In doing so, the controller 900 may check a current position of the robot 1000 in the area stored in the map storage unit 200 and provide a moving signal to the moving unit 300. The controller 900 may generate a path in real time or generate a path in a movement process by using various informations stored in the map storage unit 200.

The moving unit 300 may include a driving distance calculating unit 310 and a driving distance correcting unit 320. The driving distance calculating unit 310 may provide information on the distance traveled by the moving unit 300. According to an embodiment, the accumulated distance moved by the robot 1000 starting at a specific point may be provided. Alternatively, an accumulated distance for the robot 1000 to move linearly after rotating at a specific point may be provided. Alternatively, an accumulated distance for the robot 100 to move from a specific timing point may be provided.

In addition, according to an embodiment of the present disclosure, the driving distance calculating unit 310 may provide information on a moving distance within a predetermined unit as well as an accumulated distance. The driving distance calculating unit 310 may calculate various distances according to the characteristics of the moving unit 300. When the moving unit 300 is a wheel, the driving distance calculating unit 310 may calculate a driving distance by counting the number of rotations of the wheel.

When the distance calculated by the driving distance calculating unit 310 is different from the distance information actually calculated by the sensing module 100 of the robot 1000, the driving distance correcting unit 320 corrects the distance information calculated by the driving distance calculating unit 310. In addition, when an error occurs in a manner of being accumulated in the driving distance calculating unit 310, the controller 900 or the moving unit 300 may be informed to change the driving distance calculation logic of the driving distance calculating unit 310.

The function unit 400 means to provide a specialized function of the robot. For example, in case of a cleaning robot, the function unit 400 includes components required for cleaning. In case of a guidance robot, the function unit 400 includes components required for guidance. In case of a security robot, the function unit 400 includes components required for security. The function unit 400 may include various components according to functions provided by the robot, by which the present disclosure is non-limited.

The controller 900 of the robot 1000 may generate or update a map of the map storage unit 200. In addition, the controller 900 may identify whether an object is a moving object or a fixed object by identifying information of the object provided by the sensing module 100 during a driving process, thereby controlling the driving of the robot 1000.

In summary, when the sensing module 100 senses an object disposed outside, the controller 900 of the robot 1000 may identify a moving object among objects sensed based on the characteristic information of the sensed objects, thereby setting a current position of the robot based on the information sensed by the sensing module as a fixed object except the moving object.

In the above description, the lidar sensing unit 110 may include a laser scanner, the depth sensing unit 130 may include a 3D camera, and the vision sensing unit 130 may include a 2D camera or an RGB camera.

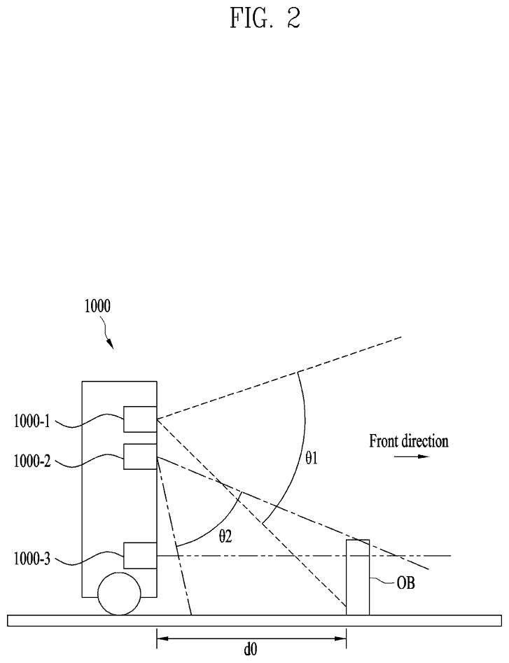

The robot 1000 may include a plurality of sensing modules 100. This will be described with further reference to FIG. 2. FIG. 2 shows a robot having a plurality of sensing modules for sensing an external object according to an embodiment of the present disclosure.

As shown in FIG. 2, a first portion 1000-1 of the robot 1000 may be provided with a first sensing module (not shown) for sensing an object located in front thereof, a second portion 1000-2 of the robot 1000 may be provided with a second sensing module (not shown) for sensing an object located below, and a the third portion 1000-3 of the robot 1000 may be provided with a third sensing module (not shown) for sensing an object located in front thereof.

The first portion 1000-1, the second portion 1000-2, and the third portion 1000-3 may be located on a side surface of a front side of the robot 1000. The first portion 1000-1 is located close to an upper end portion of the body side surface of the robot 1000, the third portion 1000-3 is located close to a lower end portion of the body side surface of the robot 1000, and the second portion 1000-2 may be located between the first portion 1000-1 and the third portion 1000-3.

The first sensing module for sensing an object located in front may include a first RGB camera and a first 3D camera capable of capturing an image forward at a first view angle θ1. The second sensing module for sensing an object located below may include a second RGB camera and a second 3D camera capable of capturing an image forward at a second view angle θ2. The third sensing module for sensing an object located in front may include a laser scanner capable of sensing an object in a substantially linear direction in front. Each of the first RGB camera, the first 3D camera, the second RGB camera, the second 3D camera, and the laser scanner may be understood as a sensor for object detection.

Each of the first RGB camera and the second RGB camera may search an edge detected from the captured image for a line segment and identify whether the line segment is closed, so as to recognize a planar object. This is described in “2-Line Exhaustive Searching for Real-Time Vanishing Point Estimation in Manhattan World” 2017 IEEE Winter Conference on Applications of Computer Vision (WACV), 2017, pp. 345-353.

Each of the first 3D camera and the second 3D camera may generate a point cloud from a captured image and recognize a planar object using a similarity of a normal vector. This is described in “Real-Time Plane Detection with Consistency from Point Cloud Sequences” Sensors 2021, 21, 140.

The laser scanner may detect a line segment object by calculating an inflection point of points sensed and extracting a line segment therefrom. This is described in “A line segment extraction algorithm using laser data based on seeded region growing” International Journal of Advanced Robotic Systems, January 2018.

Meanwhile, as shown in FIG. 2, since the first view angle θ1 of the first sensing module and the second view angle θ2 of the second sensing module overlap each other in part, the third sensing module may sense an object in a substantially linear direction in front, and thus an object OB located in an area (hereinafter, referred to as a common sensing area) away from the robot 1000 by a prescribed distance d0 may be sensed by all of the first sensing module, the second sensing module, and the third sensing module.

The number, type, and/or position of the sensing module or sensor mounted on the robot 1000 described in FIG. 2 are exemplary, and other numbers and/or different types of sensing modules or sensors can be mounted at different positions.

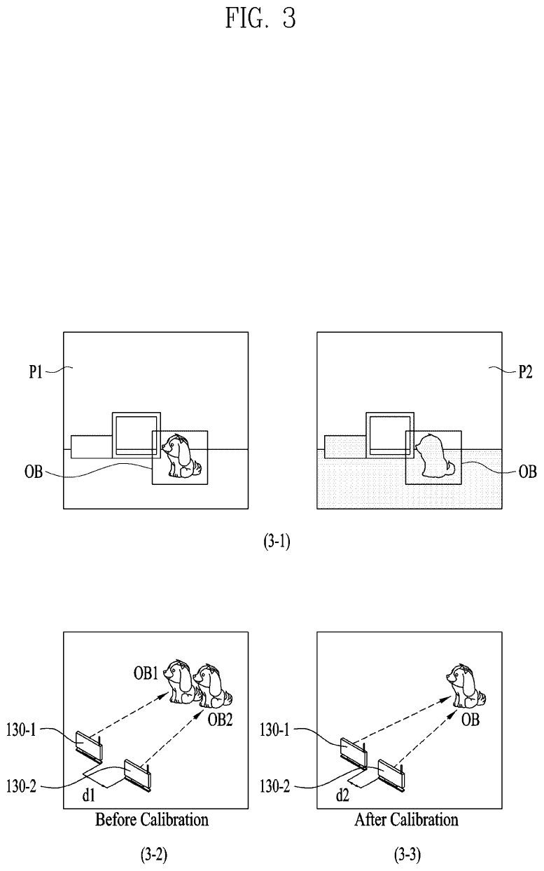

Hereinafter, object detection by a plurality of sensors before calibration and object detection by a plurality of the sensors after calibration will be described with reference to FIG. 3. FIG. 3 illustrates object detection by a plurality of sensors before calibration and object detection by a plurality of the sensors after calibration.

For clarity of description, it is assumed in FIG. 3 that a plurality of the sensors include only two RGB cameras, that is, a first RGB camera 130-1 and a second RGB camera 130-2.

Each of the first RGB camera 130-1 and the second RGB camera 130-2 may capture an image P1 including an object OB of FIG. 3 (3-1). Each of the first RGB camera 130-1 and the second RGB camera 130-2 may generate an image P2 by dividing a contour line in the image P1, and may detect the object OB from the image P2.

Yet, if the first RGB camera 130-1 and the second RGB camera 130-2 are not mounted at accurate positions (i.e. before calibration), respectively, as shown in FIG. 3 (3-2), the first RGB camera 130-1 and the second RGB camera 130-2 may recognize the object OB as different objects OB1 and OB2, respectively. FIG. 3 (3-2) exemplarily shows that the first RGB camera 130-1 and the second RGB camera 130-2 are not assembled at the accurate positions, respectively, thereby being spaced apart from each other by a first separation distance d1.

However, if the first RGB camera 130-1 and the second RGB camera 130-2 are mounted at accurate positions (i.e. after calibration), respectively, as shown in FIG. 3 (3-3), each of the first RGB camera 130-1 and the second RGB camera 130-2 may recognize the object OB as a single same object OB. FIG. 3 (3-3) exemplarily shows that the first RGB camera 130-1 and the second RGB camera 130-2 are assembled at the accurate positions, respectively, thereby being spaced apart from each other by a second separation distance d2.

Although the description of FIG. 3 is made from the perspective of the assembly positions of the sensors only, it will be readily understood by those skilled in the art that the same problem may occur if the errors occur in the direction in which the sensors are directed to the outside despite the accurate assembly positions on the robot.

The fact that the sensors are mounted on the robot to have the accurate posture may be actually implemented in hardware, or may be implemented as if the sensors are assembled to the robot to have an accurate posture in hardware actually by adjusting posture parameter values of the sensors in software. The posture parameter values will be described again later.

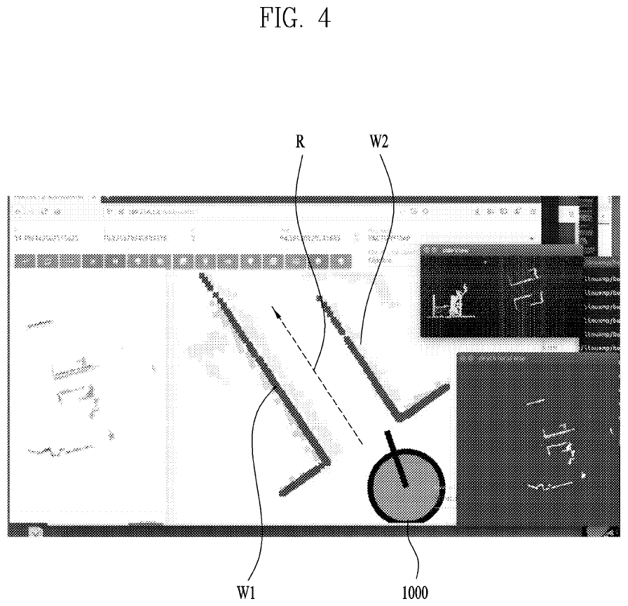

If a plurality of the sensors do not have accurate postures (i.e. calibration is not properly performed), the robot 1000 may cause various problems in operation. Representative problems thereof will be described with further reference to FIG. 4. FIG. 4 illustrates an obstacle map recognized by a robot in operation.

A path R that the robot 1000 needs to move according to the area path plan is displayed on the obstacle map. In addition, the obstacle map shows that an obstacle W1 and W2 such as a wall are located on both sides of a path R, respectively.

When the postures of the sensors assembled in the robot 1000 are not accurate, the walls W1 and W2 may be recognized to be thicker than the real from the viewpoint of the robot 1000. Therefore, although the robot 1000 is able to actually move along the path R, it may cause a problem that the robot 1000 may determine that it is unable to move along the path R due to the walls W1 and W2 recognized thick.

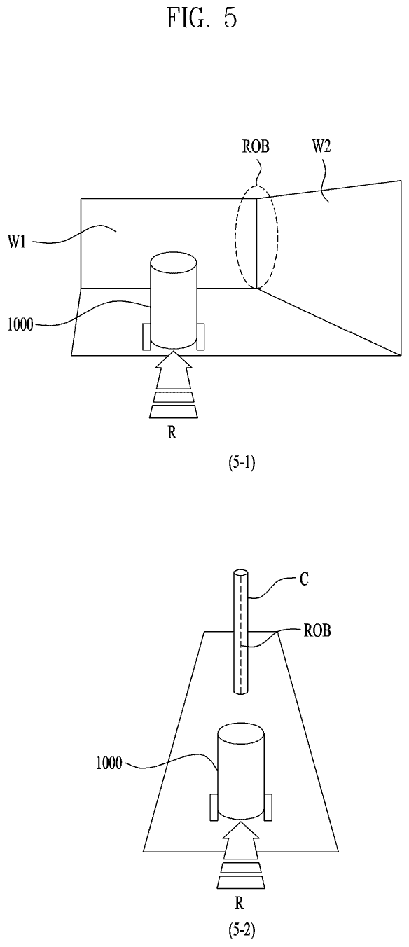

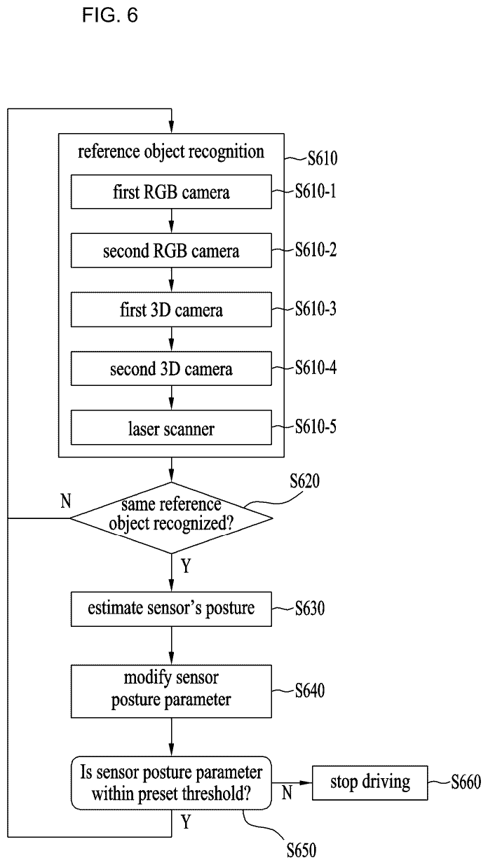

In order to solve such a problem, the robot 1000 needs to estimate the postures of the sensors assembled thereto during operation and perform posture calibration based on the posture estimation. This will be described with further reference to FIG. 5 and FIG. 6. FIG. 5 illustrates an environment in which a robot is driven according to an embodiment of the present disclosure. FIG. 6 is a flowchart for posture calibration of sensors included in a robot according to an embodiment of the present disclosure.

As shown in FIG. 5 (5-1), while the robot 1000 moves along a path R of the local path plan, it may approach a spot at which two planes W1 and W2 may meet to form a corner. In FIG. 5 (5-1), the planes are illustrated as wall surfaces, but are non-limited thereto. Then, the robot 1000 may recognize the corner edge as a reference object ROB and perform sensor posture calibration.

Alternatively, as shown in FIG. 5 (5-2), the robot 1000 may approach a cylinder C′ while moving along the path R. Then, the robot 1000 may recognize a vertical line on the side closest to the robot 1000 among side surfaces of the cylinder C′ as a reference object ROB and perform sensor posture calibration.

An order of performing sensor posture calibration based on the recognized reference object ROB will be described with reference to FIG. 6.

First, the controller 900 of the robot 1000 may recognize a reference object ROB through each of the first RGB camera, the second RGB camera, the first 3D camera, the second 3D camera, and the laser scanner [S 610]. In FIG. 6, the first RGB camera [S 610-1], the second RGB camera [S 610-2], the first 3D camera [S 610-3], the second 3D camera [S 610-4], and the laser scanner S 610-5 are illustrated as recognizing the reference object ROB in order, but the present disclosure is non-limited thereto. The reference object ROB may be recognized in a different order. Alternatively, the reference object ROB may be recognized at the same time.

Next, the controller 900 may determine whether the reference objects ROB respectively recognized by the first RGB camera, the second RGB camera, the first 3D camera, the second 3D camera, and the laser scanner are the same object [S 620].

The object identity determination may be performed by determining whether a relative position of the reference object recognized by each of the first RGB camera, the second RGB camera, the first 3D camera, the second 3D camera, and the laser scanner with respect to the robot is within a predetermined range. That is, when the relative position of the reference object recognized through each of them with respect to the robot is within the predetermined range, the controller 900 may admit the object identity. Otherwise, the controller 900 may deny the object identity.

Whether it is within the predetermined range according to the relative position may be determined depending on whether a separation distance between the reference objects recognized through the sensors is less than 5 cm or whether a difference angle between the directions in which the sensors face the recognized reference objects from the robot 1000, respectively is less than 5 degrees for example.

When the object identity with respect to the reference object ROB is denied, the controller 900 may continue to perform the step S 610.

When the object identity for the reference object ROB is admitted, the controller 900 may estimate postures of the sensors, that is, the first RGB camera, the second RGB camera, the first 3D camera, the second 3D camera, and the laser scanner, using the reference object ROB [S 630].

As described above, the third sensing module including the laser scanner is mounted on a third portion located close to the lower end portion of the robot 1000 as described above. Since the lower end portion of the body of the robot 1000 is located close to the ground, the impact generated during operation and the body twisting thereof may be relatively small.

That is, the controller 900 may estimate that the laser scanner maintains an existing assembly posture as it is.

Accordingly, the controller 900 may use the position of the reference object derived by the laser scanner as a reference position of the reference object.

The controller 900 may compare the position of the reference object derived by each of the other sensors (i.e. the first RGB camera, the second RGB camera, the first 3D camera, and the second 3D camera) with the reference position.

If the position of the reference object derived by the other sensor is the same as the reference position, the controller 900 may estimate that the other sensor maintains the existing assembly posture as it is.

Yet, when the position of the reference object derived by the other sensor is different from the reference position, the controller 900 may estimate a current mounting position of the other sensor by reversely computing how the current mounting posture of the other sensor is changed from the existing assembly posture based on a difference value between the reference position and the position of the reference object derived by the other sensor.

Then, the controller 900 may modify a current sensor posture parameter value of the other sensor so that the position of the reference object derived by the other sensor becomes the same as the reference position [S 640].

The position of the reference object derived by each sensor may be calculated based on a current sensor posture parameter value of each sensor. The current sensor posture parameter value may be set from factory shipment, or may be a value that has been modified one or more times in the past from the sensor posture parameter value set at the factory shipment.

In more detail, the robot 1000 may have a posture parameter value for each sensor from factory shipment. The posture parameter value is data indicating a prescribed posture in which each sensor is mounted on the robot (i.e., to face a prescribed direction at a prescribed position). Even if the same sensor is mounted, a position of an external object detected through the same sensor may vary depending on the posture mounted on the robot. Therefore, in order to detect an accurate position of an object, the posture parameter value needs to be preset in the robot.

The current sensor posture parameter may be modified to a new sensor posture parameter value such that the position of the reference object derived by the other sensor may become equal to the reference position.

Next, the controller 900 may determine whether a difference between any one of the sensor posture parameter value before modification and the sensor posture parameter value on factory shipment of the robot and the sensor posture parameter after the modification is within a preset threshold [S650].

For example, if the sensor posture parameter value is modified so that a mounting position of the sensor is changed to a position within 3 cm or a mounting direction of the sensor is changed to a direction within 3 degrees, the controller 900 may determine that the difference is within the preset threshold.

When the difference is within the threshold, the controller 900 may control the robot 1000 to perform the step S 610 while continuously moving along the path R.

Yet, when the difference is out of the threshold, the controller 900 may determine that the instrument assembly state of the robot 1000 is damaged, stop the operation of the robot 1000, and control the communication unit 500 to inform a robot control center (not shown) of it [S 660].

Meanwhile, in the steps S630 and S640, the position of the reference object, which is derived by the laser scanner located close to the lower end portion of the robot, is used as a reference position of the reference object, the postures of the rest of the sensors other than the laser scanner are estimated, and/or the sensor posture parameter value of each of the rest of the sensors is modified.

However, the present disclosure is non-limited thereto. For example, if another sensor is located at the lower end portion of the robot, the position of the reference object derived by the another sensor may be used as a reference position of the reference object, postures of the rest of the sensors may be estimated, and/or a sensor posture parameter value of each of the rest of the sensors may be modified.

In addition, if a sensor is at a position at which an assembly posture of the sensor may be maintained for a long time against external impact owing to a unique shape of the robot instead of the lower end portion, a position of the reference object derived by the sensor at the corresponding position may be used as a reference position of the reference object, postures of the rest of the sensors may be estimated, and/or a sensor posture parameter value of each of the rest of the sensors may be modified.

Besides, an average position of the reference object derived by each of a plurality of the sensors may be used as a reference position, postures of a plurality of the sensors may be estimated, and/or a sensor posture parameter value of each of a plurality of the sensors may be modified.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

What is claimed is:

1. A method of calibrating a robot sensor, the method comprising:
detecting a reference object through a plurality of sensors of a robot during driving along a path according to a local path plan; and
modifying a sensor posture parameter value for each of at least one or more of the rest of sensors among a plurality of sensors based on a position of the reference object sensed by a specific one of a plurality of the sensors.

2. The method of claim 1, wherein the modifying the sensor posture parameter value comprises modifying the sensor posture parameter value so that the position of the reference object sensed by each of the rest of the sensors becomes the same as the position of the reference object sensed by the specific sensor.

3. The method of claim 2, further comprising stopping the driving of the robot when a difference between the sensor posture parameter value before modification and the sensor posture parameter value after the modification is out of a preset threshold.

4. The method of claim 1, further comprising estimating postures of a plurality of the sensors based on the position of the reference object sensed through a plurality of the sensors.

5. The method of claim 1, further comprising determining identity of the reference object detected through a plurality of the sensors, wherein the modifying the sensor posture parameter value is performed based on admitting the identity of the reference object.

6. The method of claim 1, wherein the reference object is a corner at which two planes meet or a cylinder.

7. The method of claim 6, wherein the reference object is an object located in an area spaced apart by a prescribed distance from the robot so as to be sensed by all of a plurality of the sensors.

8. The method of claim 1, a plurality of the sensors comprising:
a first RGB camera and a first 3D camera for sensing an object located in front;
a second RGB camera and a second 3D camera for sensing an object located below; and
a laser scanner for sensing an object positioned in front.

9. The method of claim 7, wherein the first RGB camera and the first 3D camera are located close to an upper end portion of the robot, wherein the laser scanner is located close to a lower end portion of the robot, wherein the second RGB camera and the second 3D camera are located between the first RGB camera and the first 3D camera and the laser scanner, and wherein the specific sensor is the laser scanner.

10. The method of claim 1, further comprising modifying the sensor posture parameter value for each of a plurality of the sensors based on an average position of the reference object sensed by a plurality of the sensors.

11. A robot, comprising:
a moving unit configured to move the robot;
a plurality of sensors configured to sense an external object; and
a controller configured to detect a reference object through a plurality of the sensors during driving along a path according to a local path plan and modify a sensor posture parameter value for each of at least one of the rest of a plurality of the sensors based on a position of the reference object sensed by a specific one of a plurality of the sensors.

12. The robot of claim 11, wherein the controller modifies the sensor posture parameter value so that the position of the reference object sensed by each of the rest of the sensors becomes the same as the position of the reference object sensed by the specific sensor.

13. The robot of claim 12, wherein the controller stops the driving of the robot when a difference between the sensor posture parameter value before modification and the sensor posture parameter value after the modification is out of a preset threshold.

14. The robot of claim 11, wherein the controller estimates postures of a plurality of the sensors based on the position of the reference object sensed through a plurality of the sensors.

15. The robot of claim 11, wherein the controller determines identity of the reference object detected through a plurality of the sensors and modifies the sensor posture parameter value based on admitting the identity of the reference object.

16. The robot of claim 11, wherein the reference object is a corner at which two planes meet or a cylinder.

17. The robot of claim 16, wherein the reference object is an object located in an area spaced apart by a prescribed distance from the robot so as to be sensed by all of a plurality of the sensors.

18. The robot of claim 11, a plurality of the sensors comprising:
a first RGB camera and a first 3D camera for sensing an object located in front;
a second RGB camera and a second 3D camera for sensing an object located below; and
a laser scanner for sensing an object positioned in front.

19. The robot of claim 17, wherein the first RGB camera and the first 3D camera are located close to an upper end portion of the robot, wherein the laser scanner is located close to a lower end portion of the robot, wherein the second RGB camera and the second 3D camera are located between the first RGB camera and the first 3D camera and the laser scanner, and wherein the specific sensor is the laser scanner.

20. The robot of claim 11, wherein the controller modifies the sensor posture parameter value for each of a plurality of the sensors based on an average position of the reference object sensed by a plurality of the sensors.
